(19) United States
(12) Patent Application Publication
(10) Pub. No.: US 2015/0101451 A1
(43) Pub. Date: Apr. 16, 2015

(54) Torsional Vibration Deletion Means as well as Torsional Vibration Damper for a Vehicle Drive-Line

(71) Applicant: ZF Friedrichshafen AG, Friedrichshafen (DE)

(72) Inventors: Bastian Volpert, Friedrichshafen (DE); Michael Wechs, Lindau (DE); Thomas Mauz, Langenargen (DE)

(21) Appl. No.: 14/510,614

(22) Filed: Oct. 9, 2014

(30) Foreign Application Priority Data
Oct. 11, 2013 (DE) 10 2013 220 534.1

(51) Int. Cl. F16F 15/14

(52) U.S. Cl. CPC F16F 15/145
USPC 74/574.2

(57) ABSTRACT

The invention relates to a torsional vibration absorber, comprising a rotatable support disc and several pendulum masses, which are hinged in an oscillating manner on the support disc in particular and are thereby able to move relative to the support disc along the associated pendulum rails. In order to create a torsional vibration absorber, through which several excitation orders are able to be absorbed with a simultaneously compact structure, the pendulum masses combine at least one pair of pendulum masses, with which the two associated pendulum masses are coupled to each other through at least one intermediate spring element. In addition, the invention relates to a torsional vibration damper, with which at least one aforementioned torsional vibration absorber is applied.

### FIELD OF THE INVENTION

The invention relates to a torsional vibration absorber, comprising a rotatable support disc and several pendulum masses that are hinged in an oscillating manner on the support disc and are thereby able to move relative to the support disc along associated pendulum rails. In addition, the invention relates to a torsional vibration damper, with which at least one aforementioned torsional vibration absorber is applied.

### BACKGROUND

In drive trains of motor vehicles, torsional vibration dampers, mostly in the form of dual-mass flywheels, are typically used for the dampening of torsional vibrations. These torsional vibrations, which are caused by rotational irregularities in the operation of an internal combustion engine of the motor vehicle, would, upon an undamped introduction into the following drive train, have the consequence of humming noises and transmission rattling noises, which would also reach the interior of the vehicle through the path of the structure-borne noise and airborne noise and thereby reduce driving comfort. In addition, torsional vibrations may cause increases in the dynamic torque, which would adversely affect the service life of components in the drive train, in particular those of the transmission. For the improvement of the decoupling quality with torsional vibration absorbers, torsional vibration dampers are frequently used; these possess a variable natural frequency that changes proportionally to the rotational speed. Thereby, the damping effect of the particular torsional vibration damper can be clearly improved through such a torsional vibration absorber, by the particular absorber being tailored to the defined excitations of the particular internal combustion engine, typically the excitations of the second engine order, which are caused in particular by an ignition frequency of the internal combustion engine.

DE 10 2009 051 724 A1 shows a torsional vibration damper in the form of a dual-mass flywheel, which includes a torsional vibration absorber. Thereby, with this torsional vibration absorber, multiple pendulum masses are applied in an oscillating manner at a rotating support disc, and may carry out relative movements relative to the support disc along associated pendulum rails.

### SUMMARY OF THE INVENTION

Starting from the state of the art described above, it is now the task of this invention to create a torsional vibration absorber through which several excitation orders are able to be absorbed with a simultaneously compact structure. Additional objects and advantages of the invention will be set forth in part in the following description, or may be obvious from the description, or may be learned through practice of the invention.

The tasks are solved by the distinctive characteristics of the torsional vibration absorber claimed herein. Each of the claims describes advantageous aspects and embodiments of the invention. A torsional vibration damper, with which at least one torsional vibration absorber in accordance with the invention is applied, is also encompassed by the invention.

In accordance with the invention, a torsional vibration absorber comprises a rotatable support disc and several pendulum masses, which are hinged in an oscillating manner on the support disc and are thereby able to move relative to the support disc along associated pendulum rails. Torsional vibration dampers, with which at least one torsional vibration absorber in accordance with the invention is applied, preferably comprises a dual-mass flywheel for a drive train of a motor vehicle, with which, in a manner known in principle to the specialist, a primary mass on the side of the internal combustion engine is connected to a secondary mass on the side of the transmission through a spring-damping system.

The invention includes the technical teaching that the pendulum masses of the torsional vibration absorber in accordance with the invention combine at least one pair of pendulum masses, with which the two associated pendulum masses are coupled to each other through at least one intermediate spring element. In other words, the pendulum masses are thus combined into pairs, whereas, with one pair of pendulum masses, at least one spring element is provided between the two corresponding masses. The spring element establishes a connection between the pendulum masses.

Such an arrangement of a torsional vibration absorber thereby has the advantage that, through the coupling of the corresponding pendulum masses of a pair of pendulum masses, a vibrating system with two natural angular frequencies can be provided, through which two orders of rotational irregularities can be absorbed accordingly. This is because, due to the coupling of the two pendulum masses of a pair of pendulum masses, in the event of excitation of the first natural angular frequency, the two pendulum masses vibrate in phase, whereas, in the event of excitation of the second natural angular frequency, an out-of-phase vibration of the two pendulum masses occurs. Subsequently, both pendulum masses of a pair of pendulum masses together cause the absorption of torsional vibrations with both the one and the other natural angular frequency, such that, upon a corresponding design, the pendulum masses are always involved in the absorption of relevant torsional vibrations. Accordingly, an absorption of two torsional vibration orders with a low number of pendulum masses, and thus a low total pendulum mass is possible, which enables a correspondingly compact structure and light weight.

Thereby, the absorption of two orders of rotational irregularities is of particular interest for drive trains, for which, with an internal combustion engine, cylinder cut-offs can be realized, in order to reduce fuel consumption and thus CO2 emissions in the partial load range of the internal combustion engine. This is because the cutting off of individual cylinders of an internal combustion engine has a significant effect on the excitation orders of rotational irregularities. Thus, a main excitation order upon the cutting off of cylinders, compared to a fully-fired operation of the internal combustion engine, with which excitations upon a second order occur, shifts into the area of a first engine order. Upon the use of a torsional vibration absorber with only one natural angular frequency, this would have the consequence that insufficient absorption would occur in the area of one of the orders. The consequence would be a corresponding reduction in comfort, along with a higher burden of the components of the following drive train.

With a torsional vibration absorber, such as that described in DE 10 2009 051 724 A1, there could only be a reaction to such presence of two dominant orders of rotational irregularities, by, from the existing pendulum masses, one or more pendulum masses being drawn upon to absorb the torsional vibrations of the one order, and one or more masses being used to absorb torsional vibrations of the other order. As a consequence, the pendulum masses to be provided are only involved in the absorption of one of the dominant orders of rotational irregularities, which, for the production of sufficient absorption, would have a corresponding large number of pendulum masses. Since, in addition, in drive trains of motor vehicles, relatively high rotational vibration amplitudes are to be absorbed, and pendulum masses are to be accordingly designed with a large size, this would have the consequence of a high total weight, and a higher space requirement of a torsional vibration absorber.

In terms of the invention, with a torsional vibration absorber in accordance with the invention, an even number of pendulum masses is preferably provided, whereas all pendulum masses are thereby combined into pairs. However, under certain circumstances, it is likewise also easily conceivable that an odd number of pendulum masses is provided, whereas one pendulum mass then remains uncoupled.

Within one pair of pendulum masses, the two pendulum masses may be coupled to each other through one or more intermediate spring elements, whereas the spring elements are thereby particularly arranged in a circumferential direction viewed between the pendulum masses. In addition, at least one spring element in particular comprises one coil spring, but other versions are also conceivable.

For the design of the two natural angular frequencies of the torsional vibration absorber, with the at least one pair of pendulum masses, the mass of the particular pendulum mass, the particular moment of inertia of the particular pendulum mass, the gap of a center of rotation of the support disk to an effective hinge point of the particular pendulum mass, the gap of the effective hinge point of the particular pendulum mass to its particular center of gravity, along with the at least one intermediate spring element will vary. Through the coordination of the aforementioned parameters with each other, the natural angular frequencies of the torsional vibration absorber suitable for the particular application can be defined.

According to one embodiment of the invention, the at least one spring element is tethered to the centers of mass of the associated pendulum masses. This reliably prevents a tilting of the pendulum masses in relation to the coupling.

In an additional form of the invention, the spring stiffness of the at least one spring element is adaptable depending on the rotational speed of the support disc. This has the advantage that an optimal decoupling quality can be achieved over a wide range of rotational speeds. Preferably, the spring stiffness is thereby adaptable through the centrifugal force, by which a passive adaptive control of the spring stiffness can be realized, since the centrifugal force is directly proportional to the square of the rotational speed. However, an otherwise passive, semi-active or active adjustment of the spring stiffness can likewise also be easily provided.

There is an additional advantageous arrangement of the invention with which the one spring element on the part of the support disc is guided transverse to a coupling device of the two corresponding pendulum masses. Thereby, such an arrangement of a torsional vibration absorber has the advantage that a tilting of the at least one spring element upon a coupling of the two pendulum masses can also be prevented, which, similar to a tilting of the two pendulum masses, would have negative effects on the functioning of the vibration system.

With an additional form of the invention, with the at least one pair of pendulum masses, the one pendulum mass is hinged with a first effective pendulum length at a first effective hinge point of the support disc, which is underneath a first gap at a center of rotation of the support disc. However, the other pendulum mass of the least one pair of pendulum masses is hinged with a second effective pendulum length at a second effective hinge point of the support disc, which is underneath a second gap at a center of rotation of the support disc. The pendulum masses of the at least one pair of pendulum masses are hinged with varying gaps at the center of rotation of the support disc, and are also guided with varying pendulum lengths. As also described above, the pendulum masses may also vary in terms of their masses along with their moments of inertia. However, in terms of the invention, it is also conceivable that the pendulum masses are to be designed equally in terms of their masses, their moments of inertia, their effective hinge point along with their effective pendulum lengths.

According to an additional advantageous embodiment of the invention, the pendulum masses of the at least one pair of pendulum masses are hinged through two coupling pins on the support disc, whereas the coupling pins allocated to one pendulum mass are underneath a gap at a center of rotation of the support disc, and bordered on the part of the associated pendulum mass in each associated coupling hole. Subsequently, a two-point suspension of the pendulum mass is formed on the support disc, whereas the coupling pins that are underneath a gap at the center of rotation thereby define an effective hinge point of the particular pendulum mass. A definition of the effective pendulum length is effected through the interaction of the coupling pins with the coupling holes. The pendulum masses are thereby preferably designed in kidney shape.

With one torsional vibration damper, which is particularly designed in the form of a dual-mass flywheel, the at least one torsional vibration absorber is then provided on the sides of a secondary mass, i.e. in the drive train on the part of the transmission. In addition, the at least one torsional vibration absorber thereby preferably possesses two pairs of pendulum masses.

The invention is not limited to the specified combination of the characteristics of the main claim or the claims dependent on it. There are also options for combining with each other individual characteristics with one another, and to the extent that they arise from the claims, the following description of the preferred embodiment of the invention or directly from the drawings. Any reference of the claims to the drawings through the use of reference signs should not restrict the scope of protection of the claims.

### BRIEF DESCRIPTION OF THE DRAWINGS

An advantageous arrangement of the invention, which is described below, is shown in the drawings. The following is shown:

FIG. 1 a physical model of a torsional vibration absorber in accordance with the invention according to a preferred embodiment of the invention; and

FIG. 2 an implementation of the torsional vibration absorber of FIG. 1 with a dual-mass flywheel.

### DETAILED DESCRIPTION

Reference will now be made to embodiments of the invention, one or more examples of which are shown in the drawings. Each embodiment is provided by way of explanation of the invention, and not as a limitation of the invention. For example features illustrated or described as part of one embodiment can be combined with another embodiment to yield still another embodiment. It is intended that the present invention include these and other modifications and variations to the embodiments described herein.

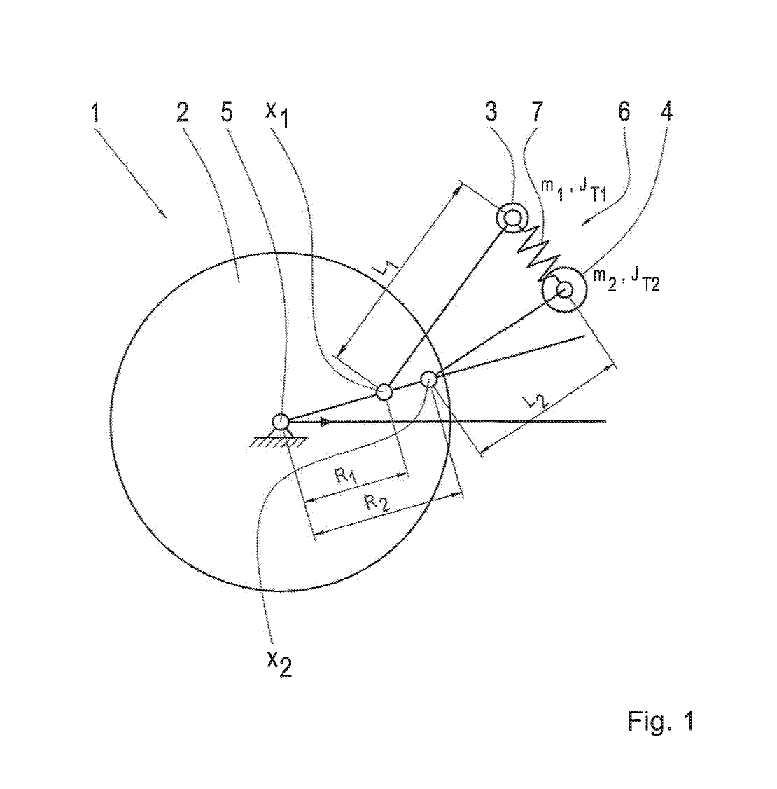

FIG. 1 shows a physical model of a torsional vibration absorber 1 according to a preferred embodiment of the invention. With this torsional vibration absorber 1, a rotating support disc 2, at which two pendulum masses 3 and 4 are hinged, is provided. Thereby, the pendulum mass 3 features a mass m₁ and a moment of inertia J_{T1}, while the pendulum mass 4 is designed with a mass m₂ and a moment of inertia J_{T2}.

As can be further seen in FIG. 1, the two pendulum masses 3 and 4 are hinged variously at the support disc 2, by the pendulum 3 linking with an effective pendulum length L₁ at an effective point x₁, which is thereby beneath a gap R₁ to a center of rotation 5 of the support disc 2, whereby this is realized, in the case of the pendulum mass 4, at an effective hinge point x₂ and a gap R₂, and under an effective pendulum length L₂.

A special factor is that, with the torsional vibration absorber 1 in accordance with the invention, two natural angular frequencies are defined by the fact that the two pendulum masses 3 and 4 are combined at one pair of pendulum masses 6, by the two pendulum masses 3 and 4 being coupled to each other by means of a spring element 7. This coupling thereby has the consequence that the pendulum masses 3 and 4, in the event of excitation of the first natural angular frequency, vibrate in phase, while, in the event of excitation of the second natural angular frequency, an out-of-phase vibration of the two pendulum masses 3 and 4 occurs. As a consequence of this, the torsional vibration absorber 1 is able to absorb excitations with the two natural angular frequencies and upon a corresponding design of the two dominant orders of rotational irregularities, whereas, in the respective absorption, both pendulum masses 3 and 4 are involved at the same time.

In the present case, the spring element 7 is designed with a spring stiffness c, which changes depending on the rotational speed of the support disc 2, whereas this adjustment is thereby undertaken under the utilization of the centrifugal force. As can also be seen in FIG. 1, the spring element 7 touches both the pendulum mass 3 and the pendulum mass 4, in each case at a center of mass. This prevents an inadvertent tilting the pendulum masses 3 and 4 when executing movements at the associated pendulum rails upon the coupling of the spring element 7.

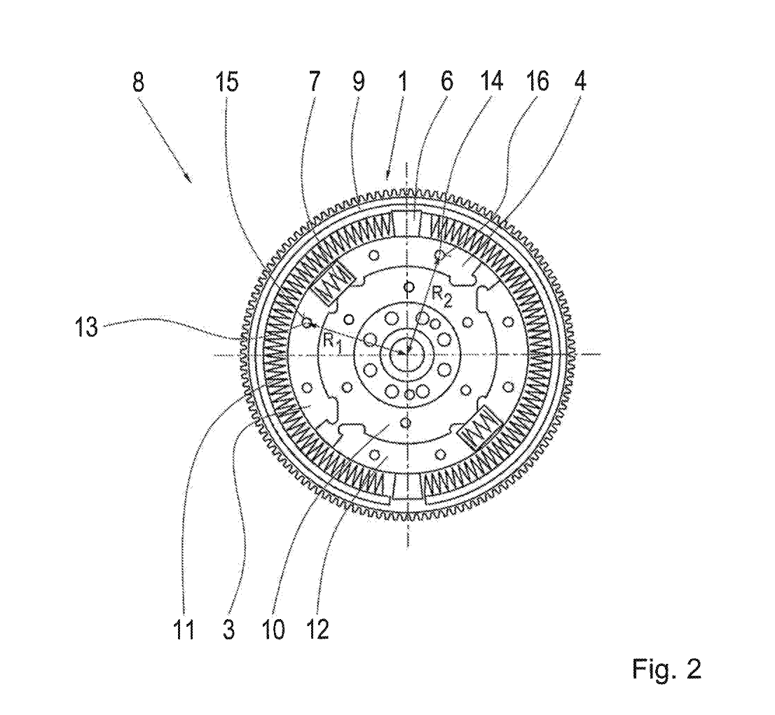

In addition, in FIG. 2, a side view of a torsional vibration damper in the form of a dual-mass flywheel 8 can be seen; in a manner known in principle to the specialist, this is composed of a primary mass 9 and a secondary mass 10. Thereby, in the installed state of the dual-mass flywheel 8, the primary mass 9 is provided in a drive train of a motor vehicle on the part of an internal combustion engine, and the secondary mass 10 is provided at the sides of a downstream transmission. The primary mass 9 and the secondary mass 10 are also coupled through intermediate bow springs 11 in a circumferential direction.

On the part of the secondary mass 10, the dual-mass flywheel 8 is equipped with the torsional vibration absorber in accordance with the invention, whereas, upon the specific implementation compared to the physical model in FIG. 1, this is equipped with, in addition to the pair of pendulum masses 6, an additional pair of pendulum masses 12, but, in terms of structure and connection, corresponds to the pair of pendulum masses 6. The support disc 2 of the torsional vibration absorber 1 present in FIG. 1 is, upon the application with the dual-mass flywheel 8 in FIG. 2, formed through the secondary mass 10.

As can be seen in FIG. 2, a connection of the pendulum masses 3 and 4, designed in kidney shape, is undertaken at the secondary mass 10 through the coupling pins 13 or 14, as the case may be, which are underneath the associated gap R₁ and R₂ at a pivot point of the secondary mass 10. At the coupling pins 13 or 14, as the case may be, the respective pendulum mass 3 or 4, as the case may be, is then received with the associated coupling hole 15 or 16, as the case may be, which, in the interaction with the coupling pins 13 or 14, as the case may be, define the effective pendulum lengths L₁ or L₂, as the case may be, of the physical mode from FIG. 1.

The spring element 7 coupling the pendulum masses 3 and 4 to each other is also guided transverse to a coupling device of the two pendulum masses 3 and 4, i.e. in a radial direction, on the part of the secondary mass 10, by which, in addition to preventing a tilting of the pendulum masses 3 and 4, a tilting of the spring element 7 upon the coupling is also prevented. The guiding of the spring element 7 is thereby formed by a corresponding recess in the secondary mass 10, in which the spring element 7 runs in a manner coupling the two pendulum masses 3 and 4.

By means of the arrangement of a torsional vibration absorber in accordance with the invention, two different natural angular frequencies are able to be reliably absorbed with a simultaneously compact structure and low weight.

Modifications and variations can be made to the embodiments illustrated or described herein without departing from the scope and spirit of the invention as set forth in the appended claims.

1-10. (canceled)

11. A torsional vibration absorber, comprising:
a rotatable support disc;
a plurality of pendulum masses hinged to the support disc in a manner so as to oscillate as pendulums relative to the support disc;
a pair of the pendulum masses coupled together with an intermediate spring element; and
wherein the coupled pendulum masses define a combined pendulum mass.

12. The torsional vibration absorber as in claim 11, wherein the spring element is tethered to a center of masses of each pendulum mass of the coupled pendulum masses.

13. The torsional vibration absorber as in claim 11, wherein the spring element comprises a spring stiffness that changes as rotational speed of the rotatable support disc changes.

14. The torsional vibration absorber as in claim 13, wherein the spring stiffness of the spring element changes as a function of centrifugal force.

15. The torsional vibration absorber as in claim 11, wherein the spring element is supported by a guide in a direction transvers to a coupling direction of the spring element between the coupled pendulum masses.

16. The torsional vibration absorber as in claim 11, wherein a first one of the pendulum masses of the combined pendulum mass is hinged with a first pendulum length at a first hinge point on the support disc, the first hinge point at a first gap distance from a center of rotation of the support disc, and a second one of the pendulum masses of the combined pendulum mass is hinged with a second pendulum length at a second hinge point on the support disc, the second hinge point at a second gap distance from the center of rotation of the support disc.

17. The torsional vibration absorber as in claim 16, wherein each of the pendulum masses of the combined pendulum mass is hinged on the support disc with a coupling pin at their respective hinge point, the coupling pins engaged in respective coupling holes in the pendulum masses that define the first and second pendulum lengths.

18. A torsional vibrational damper in the form of a dual-mass flywheel for a motor vehicle drive train, the damper further comprising a torsional vibration absorber in accordance with claim 11.

19. The torsional vibrational damper as in claim 18, wherein the torsional vibrational absorber is provided on a side of a secondary mass of the dual-mass flywheel.

20. The torsional vibrational damper as in claim 18, wherein the torsional vibrational absorber comprises two of the combined pendulum masses, each of the combined masses having a pair of the pendulum masses.
